(19) United States
(12) Patent Application Publication
(10) Pub. No.: US 2005/0052501 A1
(43) Pub. Date: Mar. 10, 2005

(54) Heater for inkjet printer head and method for production thereof

(75) Inventor: Goro Nakatani, Ukyo-ku (JP)

Correspondence Address: HOGAN & HARTSON L.L.P., 500 S. GRAND AVENUE, SUITE 1900, LOS ANGELES, CA, 90071-2611, US

(73) Assignee: ROHM CO., LTD

(21) Appl. No.: 10/894,585

(22) Filed: Jul. 20, 2004

(30) Foreign Application Priority Data
Sep. 8, 2003 (JP) 2003-315068

(51) Int. Cl. B41J 2/05

(52) U.S. Cl. 347/63

(57) ABSTRACT

To provide a heater for an inkjet printer head which consumes low power or has a long service life and a high printing resolution, and a method for production thereof. A heater layer 24 covers a heater locating section 22a of a base layer 22 and a wiring layer 26. The heater layer 24 is formed of a tantalum silicon oxide (TaSiO₂) and thus has a large sheet resistance. Thus, predetermined heat can be produced on a small current. Also, since the heater layer 24 does not have to be thin, the service life of the device can be extended. In addition, the area of a heater section 24a can be reduced.

### CROSS-REFERENCE TO RELATED APPLICATION

The entire disclosure of Japanese Patent Application No. 2003-315068 filed on Sep. 8, 2003 including their specification, claims, drawings and summary is incorporated herein by reference in its entirety.

### BACKGROUND OF THE INVENTION

1. Field of the Invention

This invention relates to a heater for an inkjet printer head and a method for production thereof. More particularly, this invention relates to a heater for a print head of a thermal inkjet printer.

2. Description of a Prior Art

A heater board IC (integrated circuit) for use in a print head of a thermal inkjet printer is known (JP-A-2002-339085, for example). FIG. 6 is a view used to explain the cross-sectional configuration of part of a conventional heater board IC 2 which corresponds to one dot.

The heater board IC 2 has a base layer 4 of a silicon oxide (SiO₂), a heater layer 6 of a tantalum silicon nitride (TaSiN), a wiring layer 8, a plasma nitride film 10 of a silicon nitride (SiN), and a heater protecting layer 12 of a tantalum (Ta). The portion of the heater layer 6 which is not covered with the wiring layer 8 is a heater section 14.

When printing is performed using the heater board IC 2, printing ink is supplied onto the heater protecting layer 12 and instantaneously heated by the heater section 14. Then, the ink is squirted upward in the drawing onto a printing paper to print one dot on it. The heater board IC 2 has a multiplicity of such dot parts and can print a multiplicity of dots simultaneously.

Such a conventional heater board IC 2, however, has the following problem. In a conventional heater board IC 2, the heater layer 6 is formed of a tantalum silicon nitride and thus has a relatively small sheet resistance (about 10 to 200 Ω/□).

Thus, a large current must be applied to the heater section 14 to produce predetermined heat, which causes a large power loss at a wiring section.

When the thickness of the heater layer 6 is decreased to create a resistance in the heater section 14 which can produce the predetermined heat, the heater layer 6 is easily burned out when repeatedly heated. When the thickness of the heater layer 6 is increased to prevent burnout, the area of the heater section 14 must be increased to create a resistance in the heater section 14 which can produce the heat. That is, it is difficult to realize a heater board IC having a long service life and a high printing resolution.

### SUMMARY OF THE INVENTION

It is an object of this invention to solve the problem of the conventional heater board IC, that is, to provide a heater for an inkjet printer head which consumes low power or has a long service life and a high printing resolution, and a method for production thereof.

This invention relates to a heater for an inkjet printer head, which comprises: a base layer of an insulating material provided on a semiconductor substrate; a wiring layer of a wiring material partially covering the base layer; a heater layer of a tantalum silicon oxide covering a heater locating section, which is a portion of the base layer which is not covered with the wiring layer, and the wiring layer; and an insulating protective film of an insulating material covering the heater layer.

This invention relates to a heater for an inkjet printer head, which comprises: a base layer of an insulating material provided on a semiconductor substrate; a heater layer of a tantalum silicon oxide covering the base layer; a wiring layer of a wiring material partially covering the heater layer; and an insulating protective film of an insulating material covering a heater section, which is a portion of the heater layer which is not covered with the wiring layer, and the wiring layer.

This invention relates to a heater for an inkjet printer head, which comprises: a base layer of an insulating material provided on a semiconductor substrate; a heater layer of a tantalum silicon oxide covering at least part of the base layer; a wiring layer of a wiring material electrically connected to the heater layer; and an insulating protective film of an insulating material covering the heater layer and the wiring layer.

This invention relates to a method for producing a heater for an inkjet printer head, which comprises the steps of: providing a semiconductor substrate having a base layer of an insulating material; forming a wiring layer of a wiring material containing aluminum over the base layer; partially removing the wiring layer by etching so that the base layer is partially revealed to form a heater locating section; forming a heater layer of a tantalum silicon oxide over the heater locating section and the wiring layer by sputtering; and forming an insulating protective film of an insulating material over the heater layer.

This invention relates to a method for producing a heater for an inkjet printer head, which comprises the steps of: providing a semiconductor substrate having a base layer of an insulating material; forming a heater layer of a tantalum silicon oxide over the base layer by sputtering; forming a wiring layer of a wiring material containing aluminum over the heater layer; partially removing the wiring layer by etching so that the heater layer is partially revealed to form a heater section; and forming an insulating protective film of an insulating material over the heater section and the wiring layer.

Although the features of this invention can be expressed as above in a broad sense, the constitution and content of this invention, as well as the object and features thereof, will be apparent with reference to the following disclosure, taken in connection with the accompanying drawings.

### BRIEF DESCRIPTION OF THE DRAWINGS

FIG. 1 is a view used to explain the cross-sectional configuration of part of a heater board IC 20 which corresponds to one dot according to an embodiment of this invention;

FIG. 2A to FIG. 2C are views used to explain the procedure for producing the heater board IC 20, each illustrating the cross-section of essential part of the heater board IC 20 in each step;

FIG. 3 is a view used to explain the cross-sectional configuration of part of a heater board IC 40 which corresponds to one dot according to another embodiment of this invention;

FIG. 4A to FIG. 4C are views used to explain the procedure for producing the heater board IC 40, each illustrating the cross-section of essential part of the heater board IC 40 in each step;

FIG. 5 is a view used to explain the plan configuration of the heater board IC 20; and

FIG. 6 is a view used to explain the cross-sectional configuration of part of a conventional heater board IC 2 which corresponds to one dot.

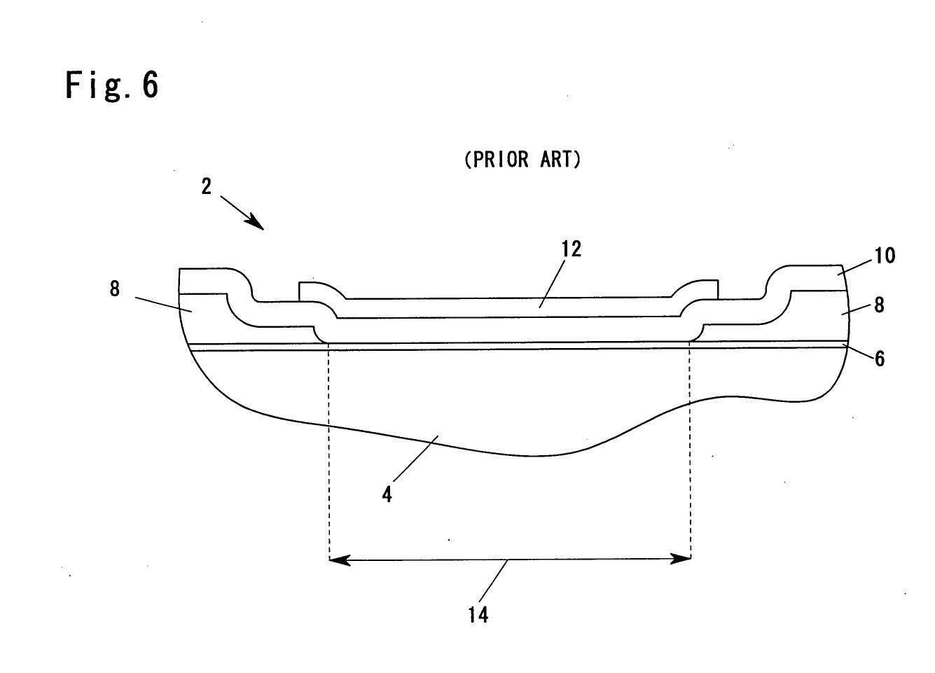

### DESCRIPTION OF THE PREFERRED EMBODIMENT

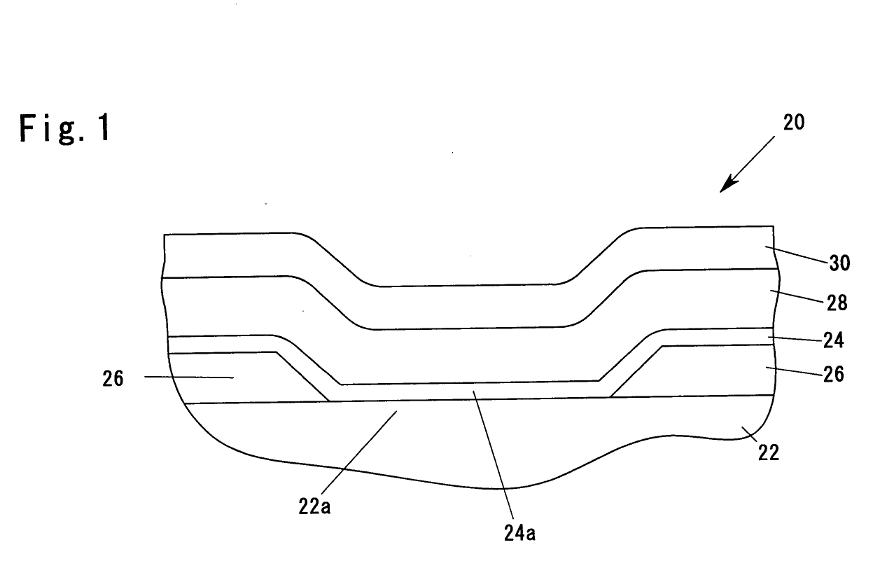

FIG. 1 is a view used to explain the cross-sectional configuration of part of a heater board IC 20 which corresponds to one dot as a heater for an inkjet printer head according to an embodiment of this invention. The heater board IC 20 is an IC (integrated circuit) for use in a print head of a thermal inkjet printer or the like.

The heater board IC 20 has a base layer 22 provided on a semiconductor substrate and a wiring layer 26 provided in contact with the base layer 22 to partially cover it. The base layer 22 is formed of a silicon oxide (SiO₂) as an insulating material. The wiring material for the wiring layer 26 is not specifically limited. In this embodiment, an aluminum-copper (Al—Cu) alloy is used as the wiring material.

The portion of the base layer 22 which is not covered with the wiring layer 26 is referred to as “heater locating section 22a”. A heater layer 24 is provided in contact with the heater locating section 22a and the wiring layer 26 to cover them. The heater layer 24 is formed of a tantalum silicon oxide (TaSiO₂).

The portion of the heater layer 24 which is located on the heater locating section 22a generates heat. This portion is referred to as “heater section 24a”.

The thickness of the heater layer 24 is not specifically limited. Preferably, the heater layer 24 has a thickness of about 200 to 1500 angstroms. When the thickness of the heater layer 24 is less than 200 angstroms, the heater layer 24 can be easily broken when heated. When the thickness of the heater layer 24 is greater than 1500 angstroms, the level difference between the heater layer 24 and the surrounding portions in the circuit is too large.

Since the heater layer 24 is formed of a tantalum silicon oxide having a large sheet resistance (about 500 Ω/□ to 20 KΩ/□), the degree of freedom in the thickness of the heater layer 24 is increased. As a result, the resistance of the heater section 24a can be selected from a wide range. In this embodiment, the resistance of the heater section 24a can be selected from a range of about 100 to 10000 ohms.

A plasma nitride film 28 (plasma-silicon nitride film, P—SiN) as an insulating protective film is provided in contact with the heater layer 24 to cover it. The plasma nitride film 28 is formed of a silicon nitride (SiN) as an insulating material.

The thickness of the plasma nitride film 28 is not specifically limited. In this embodiment, the plasma nitride film 28 has a thickness of about 1000 to 5000 angstroms.

A heater protecting layer 30 of an ink resistant material is provided in contact with the plasma nitride film 28 to cover at least part of it. The heater protecting layer 30 is formed of a tantalum (Ta) and provided at least over the heater section 24a.

The thickness of the heater protecting layer 30 is not specifically limited. In this embodiment, the heater protecting layer 30 has a thickness of about 1000 angstroms or greater.

When printing is performed using the heater board IC 20 constituted as described above, printing ink (not shown) is supplied onto the heater protecting layer 30 and instantaneously heated by the heater section 24a. Then, the ink is squirted onto a printing paper (not shown) to print one dot on it. The heater board IC 20 has a multiplicity of such dot parts and can print a multiplicity of dots simultaneously.

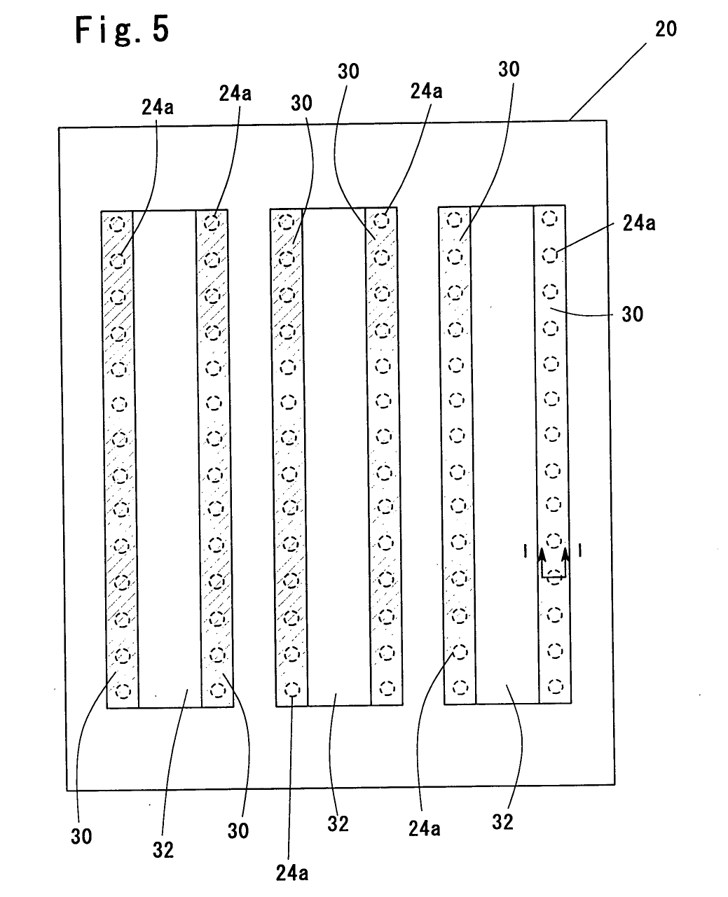

FIG. 5 is a schematic view illustrating the plan configuration of the heater board IC 20. FIG. 1 is a cross-sectional view taken along the line I-I in FIG. 5.

In the example shown in FIG. 5, one heater board IC 20 has a multiplicity of dot parts (heater sections 24a) arranged in a matrix. In this example, a plurality of heater protecting layers 30 are provided and each of the heater protecting layers 30 continuously covers the dot parts in a row. Ink supply ports 32 are provided generally in the middle between adjacent rows of the dot parts. Six rows of dot parts and three ink supply ports 32 are shown in the drawing. Ink is supplied from the ink supply ports 32 onto the heater protecting layers 30.

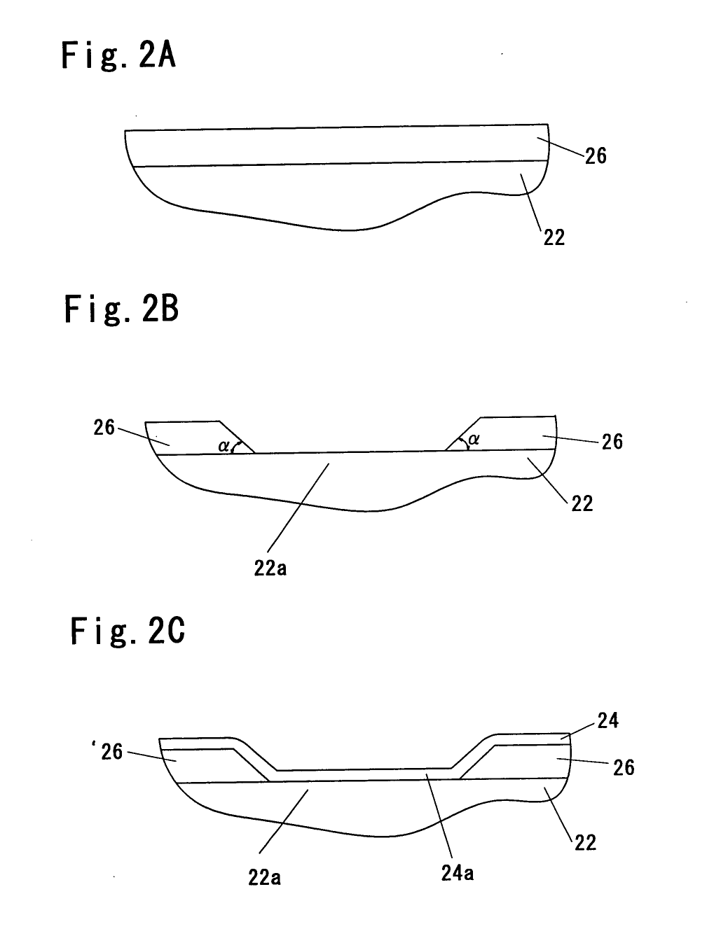

Description will be made of a method for producing the heater board IC 20. FIG. 2A to FIG. 2C are views used to explain the procedure for producing the heater board IC 20, each illustrating the cross-section of essential part of the heater board IC 20 in each step. The method for producing the heater board IC 20 will be described with reference to FIG. 2A to FIG. 2C and FIG. 1.

To produce the heater board IC 20, a semiconductor substrate having a base layer 22 of a silicon oxide (SiO₂) on it is prepared, and a wiring layer 26 of an aluminum-copper (Al—Cu) alloy is formed on the base layer 22 as shown in FIG. 2A. The method for forming the wiring layer 26 and the film thickness of the wiring layer 26 are not specifically limited. For example, the wiring layer 26 is formed by sputtering and has a film thickness of about 6000 angstroms.

Then, as shown in FIG. 2B, the wiring layer 26 is partially removed by dry etching so that the base layer 22 is partially revealed to form a heater locating section 22a.

In this embodiment, the tilt angle α of the edges of the wiring layer 26 on the heater locating section 22a side is made small (that is, acute) by controlling the etching conditions so that the etching pressure can be lower than usual, about 1.5 Pa, for example. In other words, the wiring layer 26 becomes wider toward its bottom. The acuteness of the angle α is not specifically limited. The angle α is preferably 80 to 45°, more preferably 60 to 45°, still more preferably about 45°.

When the tilt angle α is acute, the coverage of the layers to be formed on the wiring layer 26 can be improved. It is, therefore, possible to reduce poor coverage of the heater protecting layer 30, which is directly contacted with ink, for example. Thus, even when the thickness of the wiring layer 26 is increased to reduce its electric resistance, erosion of the wiring layer 26 caused by poor coverage of the heater protecting layer 30 can be prevented.

In this embodiment, the wiring layer 26 contains almost no silicon. Thus, when the wiring layer 26 is etched away, the heater locating section 22a is hardly roughened by silicon. As a result, the heater layer 24 formed in contact with the heater locating section 22a can have a flat surface.

Then, a heater layer 24 of a tantalum silicon oxide (TaSiO₂) is formed over the heater locating section 22a and the wiring layer 26 as shown in FIG. 2C. The method for forming the heater layer 24 and the thickness of the heater layer 24 are not specifically limited. In this embodiment, the heater layer 24 is formed by sputtering using a target of a tantalum silicon oxide (TaSiO₂), and has a film thickness of about 400 angstroms.

The ratio of Ta:SiO₂ in the target is preferably in the range of 50:50 to 90:10.

It is needless to say that the method for forming the heater layer 24 is not limited to the sputtering using a target of a tantalum silicon oxide (TaSiO₂) in this invention. For example, the heater layer 24 can be formed by performing sputtering using a target of a Ta and sputtering using a target of a SiO₂ alternately at a predetermined ratio.

Then, a plasma nitride film 28 is formed over the heater layer 24 by, for example, a plasma CVD method (chemical vapor deposition method) as shown in FIG. 1. The thickness of the plasma nitride film 28 is not specifically limited. In this embodiment, the plasma nitride film 28 has a thickness of about 3000 angstroms.

Then, a heater protecting layer 30 of a tantalum (Ta) is formed on the plasma nitride film 28 as shown in FIG. 1. The method for forming the heater protecting layer 30 is not specifically limited. For example, a tantalum layer is formed all over the plasma nitride film 28 by sputtering and the surface of the tantalum layer is etched to form a desired pattern on it.

The thickness of the heater protecting layer 30 is not specifically limited. In this embodiment, the heater protecting layer 30 has a thickness of about 2300 angstroms. As described above, the heater board IC 20 can be produced.

In this embodiment, the wiring layer is formed of a wiring material containing aluminum to realize a compact heater.

A wiring layer formed of a wiring material containing aluminum is, however, likely to be eroded by ink activated under high temperature. Once part of the wiring layer in the vicinity of the heater section is eroded, the erosion proceeds to the inside of the wiring layer and can cause malfunction of the device. In the heater for an inkjet printer head of this embodiment, however, the wiring layer is entirely covered with the heater layer as well as the insulating protective film. Thus, the part of the wiring layer in the vicinity of the heater section is unlikely to be eroded by ink, and the device can have a long service life.

Also in this embodiment, since the wiring layer is partially removed by dry etching so that the base layer is partially revealed to form a heater locating section, the tilt angle of the edges of the wiring layer on the heater locating section side can be made small by controlling the etching conditions. Thus, the insulating protective film can exhibit good coverage in the vicinity of the heater locating section. As a result, erosion of the wiring layer by ink can be prevented and the service life of the device can be further extended.

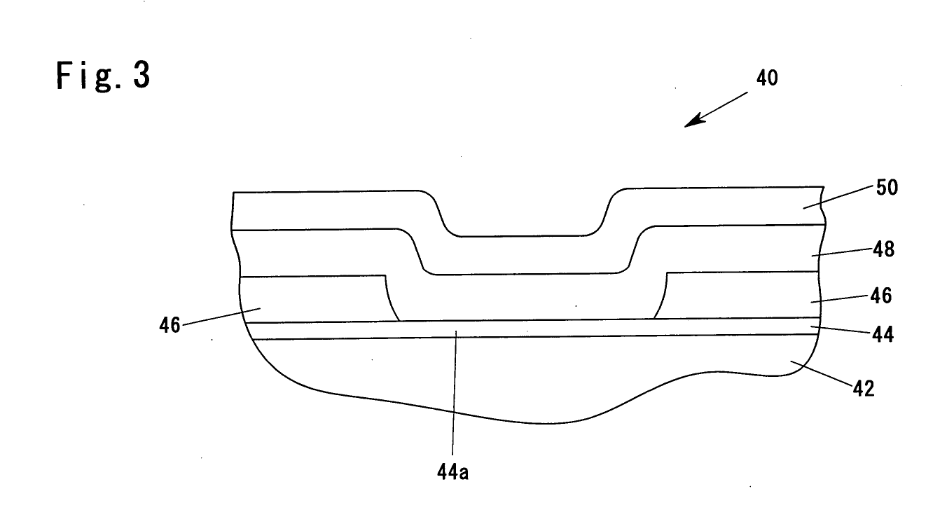

FIG. 3 is a view used to explain the cross-sectional configuration of part of a heater board IC 40 which corresponds to one dot as a heater for an inkjet printer head according to another embodiment of this invention. The heater board IC 40 is an IC for use in a print head of a thermal inkjet printer or the like as in the case with the heater board IC 20 shown in FIG. 1.

The heater board IC 40 has a base layer 42 provided on a semiconductor substrate and a heater layer 44 provided in contact with the base layer 42 to cover it. The base layer 42 is formed of a silicon oxide (SiO₂) as an insulating material. The heater layer 44 is formed of a tantalum silicon oxide (TaSiO₂).

The thickness of the heater layer 44 is not specifically limited. Preferably, the heater layer 44 has a thickness of about 200 to 1500 angstroms. When the thickness of the heater layer 44 is less than 200 angstroms, the heater layer 44 can be easily broken when heated. When the thickness of the heater layer 44 is greater than 1500 angstroms, the level difference between the heater layer 44 and the surrounding portions in the circuit is too large.

Since the heater layer 44 is formed of a tantalum silicon oxide having a large sheet resistance (about 500 Ω/□ to 20 KΩ/□), the degree of freedom in the thickness of the heater layer 44 is increased. As a result, the resistance of a heater section 44a described later can be selected from a wide range. In this embodiment, the resistance of the heater section 44a can be selected from a range of about 100 to 10000 ohms.

A wiring layer 46 is provided in contact with the heater layer 44 to partially cover it. The wiring material for the wiring layer 46 is not specifically limited. In this embodiment, an aluminum-copper (Al—Cu) alloy is used as the wiring material.

The portion of the heater layer 44 which is not covered with the wiring layer 46 is referred to as “heater section 44a”. The heater section 44a generates heat.

A plasma nitride film 48 (plasma-silicon nitride film, P—SiN) as an insulating protective film is provided in contact with the heater section 44a and the wiring layer 46 to cover them. The plasma nitride film 48 is formed of a silicon nitride (SiN) as an insulating material.

The thickness of the plasma nitride film 48 is not specifically limited. In this embodiment, the plasma nitride film 48 has a thickness of about 1000 to 5000 angstroms.

A heater protecting layer 50 of an ink resistant material is provided with the plasma nitride film 48 to cover at least part of it. The heater protecting layer 50 is formed of a tantalum (Ta) and located at least above the heater section 44a.

The thickness of the heater protecting layer 50 is not specifically limited. In this embodiment, the heater protecting layer 50 has a thickness of about 1000 angstroms or greater.

The printing method using the heater board IC 40 constituted as described above is the same as in the case of using the heater board IC 20 shown in FIG. 1, and hence the description is not given here.

The plan configuration of the heater board IC 40 is generally the same as that of the heater board IC 20 described before, and hence the description is not given here.

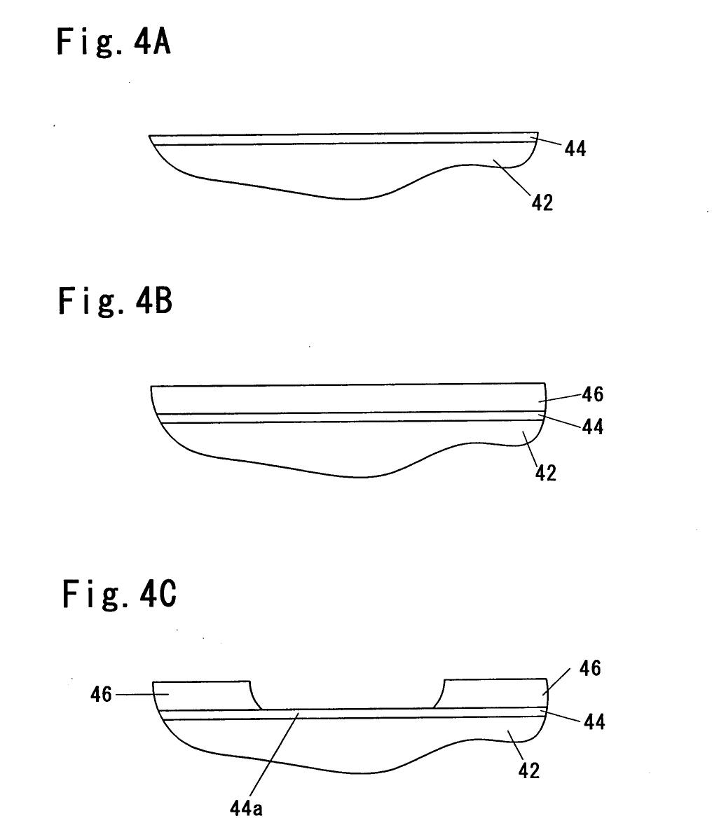

Description will be made of a method for producing the heater board IC 40. FIG. 4A to FIG. 4C are views used to explain the procedure for producing the heater board IC 40, each illustrating the cross-section of essential part of the heater board IC 40 in each step. The method for producing the heater board IC 40 will be described with reference to FIG. 4A to FIG. 4C and FIG. 3.

To produce the heater board IC 40, a semiconductor substrate having abase layer 42 of a silicon oxide (SiO₂) on it is prepared, and a heater layer 44 of a tantalum silicon oxide (TaSiO₂) is formed over the base layer 42 as shown in FIG. 4A.

The method for forming the heater layer 44 and the thickness of the heater layer 44 are not specifically limited. In this embodiment, the heater layer 44 is formed by sputtering using a target of a tantalum silicon oxide (TaSiO₂), and has a thickness of about 400 angstroms.

The ratio of Ta:SiO₂ in the target may be the same as that in the embodiment described before. Also, the method for forming the heater layer 44 is not limited to the sputtering using a target of a tantalum silicon oxide (TaSiO₂). For example, the heater layer 44 can be formed by performing sputtering using a target of a Ta and sputtering using a target of a SiO₂ alternately at a predetermined ratio as in the case with the embodiment described before.

Then, as shown in FIG. 4B, a wiring layer 46 of an aluminum-copper (Al—Cu) alloy is formed over the heater layer 44. The method for forming the wiring layer 46 and the film thickness of the wiring layer 46 are not specifically limited. For example, the wiring layer 46 is formed by sputtering and has a film thickness of about 6000 angstroms.

Then, as shown in FIG. 4C, the wiring layer 46 is partially removed by wet etching in this embodiment so that the heater layer 44 is partially revealed to form a heater section 44a. The etching conditions are not specifically limited. For example, the etching can be performed using an etching solution composed of 78.9% of phosphoric acid, 15.8% of acetic acid, 3.2% of nitric acid and 2.1% of pure water at a temperature of about 55° C.

Then, a plasma nitride film 48 is formed over the heater section 44a and the wiring layer 46 by, for example, a plasma CVD method (chemical vapor deposition method) as shown in FIG. 3. The thickness of the plasma nitride film 48 is not specifically limited. In this embodiment, the plasma nitride film 48 has a thickness of about 3000 angstroms.

Then, a heater protecting layer 50 of a tantalum (Ta) is formed on the plasma nitride film 48 as shown in FIG. 3. The method for forming the heater protecting layer 50 is not specifically limited. For example, a tantalum layer is formed all over the plasma nitride film 48 by sputtering and the surface of the tantalum layer is etched to form a desired pattern on it.

The thickness of the heater protecting layer 50 is not specifically limited. In this embodiment, the heater protecting layer 50 has a thickness of about 2300 angstroms. As described above, the heater board IC 40 can be produced.

In this embodiment, the wiring layer is formed of a wiring material containing aluminum to realize a compact heater.

In the above embodiments, the heater layer is formed by sputtering using a target of a tantalum silicon oxide (TaSiO₂). Thus, the heater layer is more stable than a heater layer formed by sputtering using a target composed of a tantalum and a silicon in an atmosphere of oxygen. Thus, there is no need to increase the area of the heater section taking into account the variations in the components thereof.

In the above embodiments, a silicon oxide, an aluminum-copper alloy, a plasma silicon nitride, and a tantalum are used as the insulating material for the base layer, the wiring material, the insulating material for the insulating protective film, the material for the heater protecting layer, respectively, of the heater board IC. However, the insulating material for the base layer, the wiring material, the insulating material for the insulating protective film, and the material for the heater protecting layer are not limited to the above materials. Different materials can be used as needed.

In the above embodiments, description has been made while taking a heater board IC as an example of a heater for an ink-jet printer head. However, a heater for an inkjet printer head is not limited to a heater board IC. In addition, this invention is applicable to a heater board IC without a heater protecting layer.

A heater for an inkjet printer head according to this invention comprises: a base layer of an insulating material provided on a semiconductor substrate; a wiring layer of a wiring material partially covering the base layer; a heater layer of a tantalum silicon oxide covering a heater locating section, which is a portion of the base layer which is not covered with the wiring layer, and the wiring layer; and an insulating protective film of an insulating material covering the heater layer.

Since the heater layer is formed of a tantalum silicon oxide, it has a large sheet resistance. Thus, predetermined heat can be produced on a small current as compared with a conventional device. As a result, power loss at a wiring section and so on can be reduced.

Also, a resistance which can produce the predetermined heat can be created in the heater section without decreasing the thickness of the heater layer. Thus, the heater layer is unlikely to be burned out even when repeatedly heated. In addition, the heater section can have a resistance to produce the heat with a relatively small area even if the heater layer has a large thickness. As a result, it is possible to realize a heater board IC having a long service life and a high printing resolution.

That is, it is possible to realize a heater for an ink-jet printer head consuming low power or having a long service life and a high printing resolution.

In the heater for an inkjet printer head according to this invention, the wiring layer has edges tilted at an acute angle α on the heater locating section side.

Since the edges of the wiring layer on the heater locating section side are sloped, the coverage of the layers formed on the wiring layer can be improved. Thus, it is possible to prevent erosion of the wiring layer by ink caused by poor coverage of the layers formed on the wiring layer even when the film thickness of the wiring layer is increased to reduce its electric resistance.

A heater for an inkjet printer head according to this invention comprises: a base layer of an insulating material provided on a semiconductor substrate; a heater layer of a tantalum silicon oxide covering the base layer; a wiring layer of a wiring material partially covering the heater layer; and an insulating protective film of an insulating material covering a heater section, which is a portion of the heater layer which is not covered with the wiring layer, and the wiring layer.

Since the heater layer is formed of a tantalum silicon oxide, it has a large sheet resistance. Thus, predetermined heat can be produced on a small current as compared with a conventional device. As a result, power loss at a wiring section and so on can be reduced.

Also, a resistance which can produce the predetermined heat can be created in the heater section without decreasing the thickness of the heater layer. Thus, the heater layer is unlikely to be burned out even when repeatedly heated. In addition, the heater section can have a resistance to produce the heat with a relatively small area even if the heater layer has a large thickness. As a result, it is possible to realize a heater board IC having a long service life and a high printing resolution.

That is, it is possible to realize a heater for an ink-jet printer head consuming low power or having a long service life and a high printing resolution.

A heater for an inkjet printer head according to this invention comprises: a base layer of an insulating material provided on a semiconductor substrate; a heater layer of a tantalum silicon oxide covering at least part of the base layer; a wiring layer of a wiring material electrically connected to the heater layer; and an insulating protective film of an insulating material covering the heater layer and the wiring layer.

Since the heater layer is formed of a tantalum silicon oxide, it has a large sheet resistance. Thus, predetermined heat can be produced on a small current as compared with a conventional device. As a result, power loss at a wiring section and so on can be reduced.

Also, a resistance which can produce the predetermined heat can be created in the heater section without decreasing the thickness of the heater layer. Thus, the heater layer is unlikely to be burned out even when repeatedly heated. In addition, the heater section can have a resistance to produce the heat with a relatively small area even if the heater layer has a large thickness. As a result, it is possible to realize a heater board IC having a long service life and a high printing resolution.

That is, it is possible to realize a heater for an ink-jet printer head consuming low power or having a long service life and a high printing resolution.

The heater for an inkjet printer head according to this invention further comprises a heater protecting layer of an ink resistant material covering at least part of the insulating protective film and provided at least over part of the heater layer which generates heat.

Since the part of the wiring layer in the vicinity of the heater section is much less likely to be eroded by ink, the service life of the device can be further extended.

A method for producing a heater for an inkjet printer head comprises the steps of: providing a semiconductor substrate having a base layer of an insulating material; forming a wiring layer of a wiring material containing aluminum over the base layer; partially removing the wiring layer by etching so that the base layer is partially revealed to form a heater locating section; forming a heater layer of a tantalum silicon oxide over the heater locating section and the wiring layer by sputtering; and forming an insulating protective film of an insulating material over the heater layer.

In a heater for an inkjet printer head produced by the above method, since the heater layer is formed of a tantalum silicon oxide, it has a large sheet resistance. Thus, predetermined heat can be produced on a small current as compared with a conventional device. As a result, power loss at a wiring section and so on can be reduced.

Also, a resistance which can produce the predetermined heat can be created in the heater section without decreasing the thickness of the heater layer. Thus, the heater layer is unlikely to be burned out even when repeatedly heated. In addition, the heater section can have a resistance to produce the heat with a relatively small area even if the heater layer has a large thickness. As a result, it is possible to realize a heater board IC having a long service life and a high printing resolution.

Also, since the wiring layer is formed of a wiring material containing aluminum, it is possible to realize a compact heater.

A wiring layer formed of a wiring material containing aluminum is likely to be eroded by ink activated under high temperature. Once part of the wiring layer in the vicinity of the heater section is eroded, the erosion proceeds to the inside of the wiring layer and can cause malfunction of the device. In the heater for an inkjet printer head of this embodiment, however, the wiring layer is entirely covered with the heater layer as well as the insulating protective film. Thus, the part of the wiring layer in the vicinity of the heater section is unlikely to be eroded by ink, and the service life of the device can be further extended.

That is, it is possible to realize a heater for an ink-jet printer head consuming low power or having a long service life and a high printing resolution.

A method for producing a heater for an inkjet printer head according to this invention comprises the steps of: providing a semiconductor substrate having a base layer of an insulating material; forming a heater layer of a tantalum silicon oxide over the base layer by sputtering; forming a wiring layer of a wiring material containing aluminum over the heater layer; partially removing the wiring layer by etching so that the heater layer is partially revealed to form a heater section; and forming an insulating protective film of an insulating material over the heater section and the wiring layer.

In a heater for an inkjet printer head produced by the above method, since the heater layer is formed of a tantalum silicon oxide, it has a large sheet resistance. Thus, predetermined heat can be produced on a small current as compared with a conventional device. As a result, power loss at a wiring section and so on can be reduced.

Also, a resistance which can produce the predetermined heat can be created in the heater section without decreasing the thickness of the heater layer. Thus, the heater layer is unlikely to be burned out even when repeatedly heated. In addition, the heater section can have a resistance to produce the heat with a relatively small area even if the heater layer has a large thickness. As a result, it is possible to realize a heater board IC having a long service life and a high printing resolution.

Also, since the wiring layer is formed of a wiring material containing aluminum, it is possible to realize a compact heater.

That is, it is possible to realize a heater for an ink-jet printer head consuming low power or having a long service life and a high printing resolution.

The method for producing a heater for an inkjet printer head according to this invention further comprises the step of forming a heater protecting layer of an ink resistant material over at least part of the insulating protective film and at least over part of the heater layer which generates heat.

In the heater for an inkjet printer head produced by the above method, the part of the wiring layer in the vicinity of the heater section is much less likely to be eroded by ink. Thus, the service life of the device can be further extended.

While this invention has been described in its preferred embodiments, it is understood that the terminology employed herein is for the purpose of description and not of limitation, and that changes and variations may be made without departing from the spirit and scope of the appended claims. Also, although only a few exemplary embodiments of this invention have been described in detail above, those skilled in the art will readily appreciate that many modifications are possible without materially departing from the novel teachings and advantages of this invention. Accordingly, all such modifications are intended to be included within the scope of this invention.

1. A heater for an inkjet printer head, comprising:
a base layer of an insulating material provided on a semiconductor substrate;
a wiring layer of a wiring material partially covering the base layer;
a heater layer of a tantalum silicon oxide covering a heater locating section, which is a portion of the base layer which is not covered with the wiring layer, and the wiring layer; and
an insulating protective film of an insulating material covering the heater layer.

2. The heater for an inkjet printer head as set forth in claim 1,
wherein the wiring layer has edges tilted at an acute angle α on the heater locating section side.

3. A heater for an inkjet printer head, comprising:
a base layer of an insulating material provided on a semiconductor substrate;
a heater layer of a tantalum silicon oxide covering the base layer;
a wiring layer of a wiring material partially covering the heater layer; and
an insulating protective film of an insulating material covering a heater section, which is a portion of the heater layer which is not covered with the wiring layer, and the wiring layer.

4. A heater for an inkjet printer head, comprising:
a base layer of an insulating material provided on a semiconductor substrate;
a heater layer of a tantalum silicon oxide covering at least part of the base layer;
a wiring layer of a wiring material electrically connected to the heater layer; and
an insulating protective film of an insulating material covering the heater layer and the wiring layer.

5. The heater for an inkjet printer head as set forth in claim 1, further comprising
a heater protecting layer of an ink resistant material covering at least part of the insulating protective film and provided at least over part of the heater layer which generates heat.

6. A method for producing a heater for an inkjet printer head, comprising the steps of:
providing a semiconductor substrate having a base layer of an insulating material;
forming a wiring layer of a wiring material containing aluminum over the base layer;
partially removing the wiring layer by etching so that the base layer is partially revealed to form a heater locating section;
forming a heater layer of a tantalum silicon oxide over the heater locating section and the wiring layer by sputtering; and
forming an insulating protective film of an insulating material over the heater layer.

7. A method for producing a heater for an inkjet printer head, comprising the steps of:
providing a semiconductor substrate having a base layer of an insulating material;
forming a heater layer of a tantalum silicon oxide over the base layer by sputtering;
forming a wiring layer of a wiring material containing aluminum over the heater layer;
partially removing the wiring layer by etching so that the heater layer is partially revealed to form a heater section; and
forming an insulating protective film of an insulating material over the heater section and the wiring layer.

8. The method for producing a heater for an inkjet printer head as set forth in claim 6, further comprising the step of
forming a heater protecting layer of an ink resistant material over at least part of the insulating protective film and at least over part of the heater layer which generates heat.

9. The heater for an inkjet printer head as set forth in claim 2, further comprising
a heater protecting layer of an ink resistant material covering at least part of the insulating protective film and provided at least over part of the heater layer which generates heat.

10. The heater for an inkjet printer head as set forth in claim 3, further comprising
a heater protecting layer of an ink resistant material covering at least part of the insulating protective film and provided at least over part of the heater layer which generates heat.

11. The heater for an inkjet printer head as set forth in claim 4, further comprising
a heater protecting layer of an ink resistant material covering at least part of the insulating protective film and provided at least over part of the heater layer which generates heat.

12. The method for producing a heater for an inkjet printer head as set forth in claim 7, further comprising the step of
forming a heater protecting layer of an ink resistant material over at least part of the insulating protective film and at least over part of the heater layer which generates heat.
